(19) United States
(12) Patent Application Publication
(10) Pub. No.: US 2025/0233199 A1
(43) Pub. Date: Jul. 17, 2025

(54) ALL-SOLID-STATE BATTERY

(71) Applicant: SAMSUNG ELECTRO-MECHANICS CO., LTD., Suwon-si, Gyeonggi-do (KR)

(72) Inventors: Youngil Lee, Suwon-si, Gyeonggi-do (KR); Kyunglock Kim, Suwon-si, Gyeonggi-do (KR); Sanghoon Ha, Suwon-si, Gyeonggi-do (KR); Youngjin Hwang, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/690,889

(22) PCT Filed: Jan. 3, 2024
(86) PCT No.: PCT/KR2024/000150

§ 371 Date: Mar. 11, 2024

(30) Foreign Application Priority Data
Apr. 10, 2023 (KR) 10-2023-0047115

(51) Int. Cl. H01M 10/0562

(52) U.S. Cl. CPC H01M 10/0562; H01M 2300/0071; H01M 2300/008

(57) ABSTRACT

An all-solid-state battery according to present disclosure includes a positive electrode layer and a negative electrode layer, and a solid electrolyte layer interposed between the positive electrode layer and the negative electrode layer, wherein the solid electrolyte layer includes a first electrolyte layer including a glass-ceramic electrolyte including lithium chloride (LiCl); and a second electrolyte layer disposed on one surface or both surfaces of the first electrolyte layer and including a lithium borosilicate (LBSO)-based electrolyte.

### TECHNICAL FIELD

The present disclosure relates to an all-solid-state battery.

### BACKGROUND ART

Recently, as portable electronic devices are required to be down-sized and used for a long term, high-capacity batteries are required, and safety of the batteries is also required due to the spread of wearable electronic devices. Accordingly, development of an all-solid-state battery using a solid electrolyte instead of a liquid electrolyte is actively progressing.

Since the all-solid-state battery does not use a flammable organic solvent, additional circuitry for safety may be simplified. Therefore, the all-solid-state battery is expected as a technology capable of manufacturing a safe battery with high capacity per unit volume.

In addition, an oxide all-solid-state battery using an oxide electrolyte with lower ionic conductivity (10⁻⁴ S/cm to 10⁻⁶ S/cm) than a sulfide electrolyte (10⁻² S/cm) requires a high-temperature sintering process but exhibits excellent stability, compared with a sulfide all-solid-state battery using the sulfide electrolyte which reacts oxygen and moisture in the air.

A stacked oxide all-solid-state battery is a micro-sized battery and thus may be mounted on a substrate like a passive device, and in addition, is stable even though exposed at a high temperature in a reflow process for this.

Research is being conducted to apply the stacked oxide all-solid-state battery to various fields, and in particular, demands for an all-solid-state battery having excellent interfacial stability and excellent ionic conductivity at the interface with an electrode are increasing.

### DISCLOSURE OF INVENTION

### Solution to Problem

Various embodiments of the present disclosure are directed to providing an allsolid-state battery with excellent interfacial stability and lithium ionic conductivity.

However, problems to be solved by the embodiments are not limited to the abovedescribed problems and may be variously expanded within the range of technical ideas included in the embodiments.

### Advantageous Effects of Invention

By providing the all-solid-state battery according to the various embodiments of the present disclosure, interfacial stability between the electrode and the solid electrolyte is improved, and ionic conductivity is improved because densification is achieved.

However, the various advantageous advantages and effects of the present disclosure are not limited to the above descriptions, and will be more easily understood in the process of describing specific embodiments of the present disclosure.

### BRIEF DESCRIPTION OF DRAWINGS

FIG. 1 is a perspective view schematically illustrating an all-solid-state battery according to an embodiment.

FIG. 2 is a cross-sectional view schematically illustrating an all-solid-state battery according to an embodiment.

FIG. 3 is a schematic cross-sectional view of an all-solid-state battery according to another embodiment.

FIG. 4 is an ion milling cross-section scanning microscope (SEM) photograph of a first electrolyte layer (top) and a second electrolyte layer (bottom).

### BEST MODE FOR CARRYING OUT THE INVENTION

An all-solid-state battery according to an embodiment includes a positive electrode layer and a negative electrode layer, and a solid electrolyte layer interposed between the positive electrode layer and the negative electrode layer, in which the solid electrolyte layer includes a first electrolyte layer including a glass-ceramic electrolyte containing lithium chloride (LiCl); and a second electrolyte layer disposed on one surface or both surfaces of the first electrolyte layer and including a lithium borosilicate-based electrolyte.

The second electrolyte layer may be disposed between the positive electrode layer or the negative electrode layer and the first electrolyte layer.

The glass-ceramic electrolyte may further include a lithium chloroboracite crystal.

The glass-ceramic electrolyte may further include lithium (Li) oxide, boron (B) oxide, silicon (Si) oxide, phosphorus (P) oxide, and germanium (Ge) oxide.

The glass-ceramic electrolyte may include 35 to 55 mol % of lithium (Li) oxide, 30 to 50 mol % of boron (B) oxide, 5 to 15 mol % of silicon (Si) oxide, 0.1 to 5 mol % of phosphorus (P) oxide, 0.1 to 5 mol % of germanium (Cc) oxide, and 0.5 to 10 mol % of lithium chloride based on a total amount of the glass-ceramic electrolyte.

The lithium borosilicate-based electrolyte may include lithium (Li) oxide, silicon (Si) oxide, and boron (B) oxide.

The lithium borosilicate-based electrolyte may include 35 to 65 mol % of lithium (Li) oxide, 5 to 25 mol % of silicon (Si) oxide, and 30 to 50 mol % of boron (B) oxide based on a total amount of the lithium borosilicate-based electrolyte.

The lithium borosilicate-based electrolyte may further include additional oxide including Na (sodium), Mg (magnesium), Al (aluminum), P (phosphorus), K (potassium), Ca (calcium), Ti (titanium), V (vanadium), Cr (chromium), Mn (manganese), Fe (iron), Co (cobalt), Ni (nickel), Cu (copper), Zn (zinc), Ga (gallium), Ge (germanium), Se (selenium), Rb (rubidium), S (sulfur), Y (yttrium), Zr (zirconium), Nb (niobium), Mo (molybdenum), Ag (silver), In (indium), Sn (tin), Sb (antimony), Cs (cesium), Ba (vanadium), Hf (hafnium), Ta (tantalum), W (tungsten), Pb (lead), Bi (bismuth), Au (gold), La (lanthanum), Nd (neodymium), Eu (europium), or a combination thereof.

The lithium borosilicate-based electrolyte may further include an additive, which includes LiF, LiCl, LiBr, LiI, Li₃N, LiPON, Li₂C₂O₄, Li₂CO₃, LiAlCl₄, Li₂O, Li₂S, LiSO₄, Li₂SO₄, Li₃PO₄, Li₃VO₄, Li₄GeO₄, Li₂Si₂O₅, Li₂SiO₃, Li₄SiO₄, Li₄ZrO₄, LiMoO₄, LiAlF₄, Li₃Ni₂, LiBF₄, LiCF₃SO₃, or a combination thereof.

A ratio of an average thickness of the first electrolyte layer and an average thickness of the second electrolyte layer may be 1:1 to 15:1.

The all-solid-state battery may further include a margin layer disposed on the solid electrolyte layer and being laterally adjacent to an edge of the positive electrode layer or the negative electrode layer.

An all-solid-state battery according to another embodiment includes a positive electrode layer and a negative electrode layer and a solid electrolyte layer interposed between the positive electrode layer and the negative electrode, in which the solid electrolyte layer includes a first electrolyte layer including a glass-ceramic electrolyte containing lithium chloride (LiCl); and a second electrolyte layer disposed on one surface of the first electrolyte layer and including a lithium borosilicate (LBSO)-based electrolyte, the first electrolyte layer is disposed between the negative electrode layer and the second electrolyte layer, and the second electrolyte layer is disposed between the positive electrode layer and the first electrolyte layer.

The glass-ceramic electrolyte may further include a lithium chloroboracite crystal.

The glass-ceramic electrolyte may further include lithium (Li) oxide, boron (B) oxide, silicon (Si) oxide, phosphorus (P) oxide, and germanium (Ge) oxide.

The glass-ceramic electrolyte may include 35 to 55 mol % of lithium (Li) oxide, 30 to 50 mol % of boron (B) oxide, 5 to 15 mol % of silicon (Si) oxide, 0.1 to 5 mol % of phosphorus (P) oxide, 0.1 to 5 mol % of germanium (Ge) oxide, and 0.5 to 10 mol % of lithium chloride may be included based on a total amount of the glass-ceramic electrolyte.

The lithium borosilicate-based electrolyte may include lithium (Li) oxide, silicon (Si) oxide, and boron (B) oxide.

The lithium borosilicate-based electrolyte may include 35 to 65 mol % of lithium (Li) oxide, 5 to 25 mol % of silicon (Si) oxide, and 30 to 50 mol % of boron (B) oxide may be included based on a total amount of the lithium borosilicate-based electrolyte.

The lithium borosilicate-based electrolyte may further include additional oxide including Na (sodium), Mg (magnesium), Al (aluminum), P (phosphorus), K (potassium), Ca (calcium), Ti (titanium), V (vanadium), Cr (chromium), Mn (manganese), Fe (iron), Co (cobalt), Ni (nickel), Cu (copper), Zn (zine), Ga (gallium), Ge (germanium), Se (selenium), Rb (rubidium), S (sulfur), Y (yttrium), Zr (zirconium), Nb (niobium), Mo (molybdenum), Ag (silver), In (indium), Sn (tin), Sb (antimony), Cs (cesium), Ba (vanadium), Hf (hafnium), Ta (tantalum), W (tungsten), Pb (lead), Bi (bismuth), Au (gold), La (lanthanum), Nd (neodymium), Eu (europium), or a combination thereof.

The lithium borosilicate-based electrolyte may further include an additive, which includes LiF, LiCl, LiBr, LiI, Li₃N, LiPON, Li₂C₂O₄, Li₂CO₃, LiAlCl₄, Li₂O, Li₂S, LiSO₄, Li₂SO₄, Li₃PO₄, Li₃VO₄, Li₄GeO₄, Li₂SiO₃, Li₂SiO₃, Li₄SiO₄, Li₂ZrO₄, LiMoO₄, LiAlF₄, Li₃Ni₂, LiBF₄, LiCF₃SO₃, or a combination thereof.

A ratio of an average thickness of the first electrolyte layer and an average thickness of the second electrolyte layer may be 1:1 to 15:1.

The all-solid-state battery may further include a margin layer disposed on the solid electrolyte layer and being laterally adjacent to an edge of the positive electrode layer or the negative electrode layer.

### MODE FOR THE INVENTION

Hereinafter, various embodiments of the present disclosure will be described in detail with reference to the accompanying drawings so that those skilled in the art may easily carry out the embodiments of the present disclosure. The drawings and description are to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present disclosure includes all modifications, equivalents, and substitutions without departing from the scope and spirit of the present disclosure. In addition, some constituent elements in the accompanying drawings are exaggerated, omitted, or schematically illustrated, and the size of each constituent element does not entirely reflect the actual size.

In addition, unless explicitly described to the contrary, the word “comprise”, and variations such as “comprises” or “comprising”, will be understood to imply the inclusion of stated elements but not the exclusion of any other elements.

Through the specification, the “stacking direction” refers to a direction in which constituent elements are sequentially stacked or the “thickness direction” perpendicular to the large surface (main surface) of the sheet-shaped constituent elements, which corresponds to a T-axis direction in the drawing. In addition, the “side direction” refers to a direction extending parallel to the large surface (main surface) from the edge of the sheet-shaped constituent elements or a “planar direction”, which corresponds to an L-axis direction in the drawing. Further, the W-axis direction in the drawing may be a “width direction”.

Hereinafter, various embodiments and modifications will be described in detail with reference to the drawings.

An all-solid-state battery according to an embodiment includes a positive electrode layer and a negative electrode layer, and a solid electrolyte layer interposed between the positive electrode layer and the negative electrode, wherein the solid electrolyte layer includes a first electrolyte layer including a glass-ceramic electrolyte including lithium chloride (LiCl); and a second electrolyte layer disposed on one surface or both surfaces of the first electrolyte layer and including a lithium borosilicate (LBSO)-based electrolyte.

An all-solid-state battery according to another embodiment includes a positive electrode layer and a negative electrode layer, and a solid electrolyte layer interposed between the positive electrode layer and the negative electrode, wherein the solid electrolyte layer includes a first electrolyte layer including a glass-ceramic electrolyte including lithium chloride (LiCl); and a second electrolyte layer disposed on one surface of the first electrolyte layer and including a lithium borosilicate (LBSO)-based electrolyte, the first electrolyte layer is disposed between the negative electrode layer and the second electrolyte layer, and the second electrolyte layer is disposed between the positive electrode layer and the first electrolyte layer.

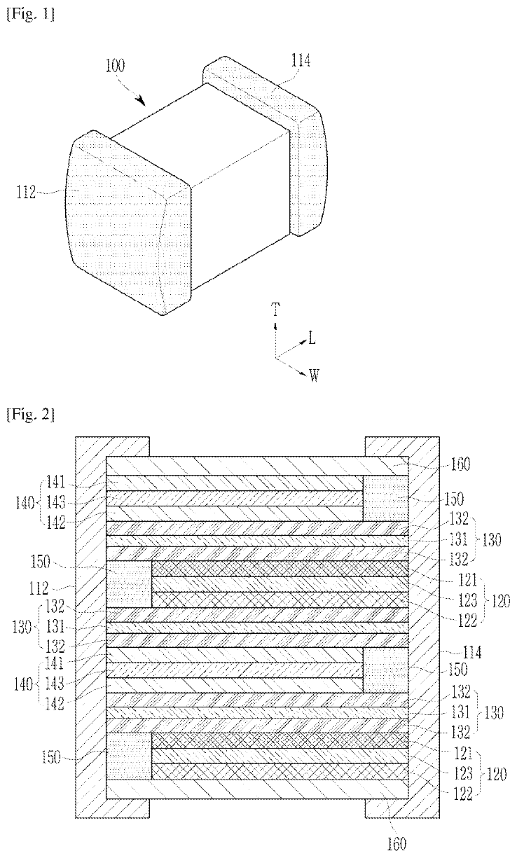

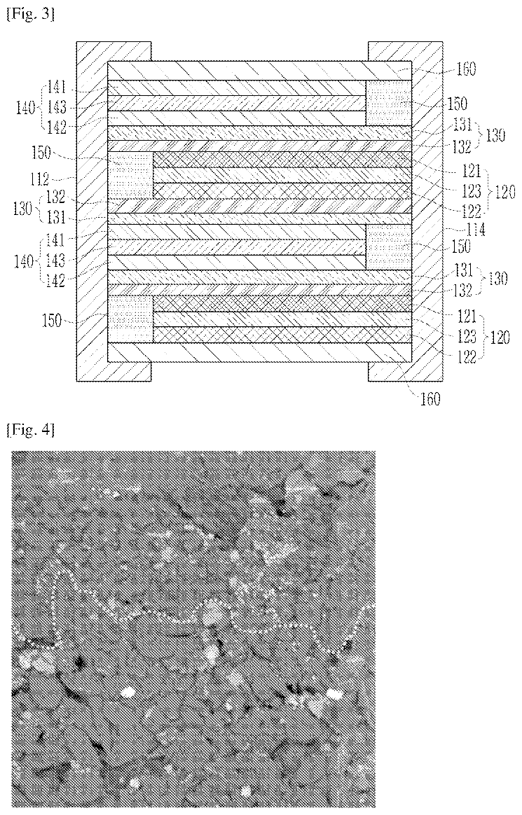

FIG. 1 is a perspective view schematically illustrating an all-solid-state battery according to an embodiment. FIG. 2 is a cross-sectional view schematically illustrating an all-solid-state battery according to an embodiment, and FIG. 3 is a schematic cross-sectional view of an all-solid-state battery according to another embodiment.

The all-solid-state battery 100 may have, for example, an approximate hexahedral shape.

An all-solid-state battery 100 according to an embodiment includes electrode layers 120 and 140 and a solid electrolyte layer 130 adjacent to the electrode layers 120 and 140 in a stacking direction. The electrode layers 120 and 140 include a positive electrode layer 120 and a negative electrode layer 140, and basically the current collectors 123 and 143 and the active material layers 121, 122, 141, and 142 coated on at least one surface of the current collectors 123 and 143.

The positive electrode layer 120 is formed by coating the positive electrode active material layers 121 and 122 on at least one surface of the positive electrode current collector 123, and the negative electrode layer 140 is formed by coating the negative electrode active material layers 141 and 142 on at least one surface of the negative electrode current collector 143.

For example, in the stacking direction, the lowermost electrode layer is formed by coating the positive electrode active material layer 122 on one surface of the positive electrode current collector 123, and the uppermost electrode layer may be formed by coating the negative electrode active material layer 141 on one surface of the negative electrode current collector 143. In addition, the electrode layers between the uppermost and lowermost ends are formed by coating the positive electrode active material layers 121 and 122 on both surfaces of the positive electrode current collector 123, or the negative electrode active material layers 141 and 142 are formed on both surfaces of the negative electrode current collector 143.

The positive electrode active material layers 121 and 122 may include a positive electrode active material and, optionally, a solid electrolyte. In addition, the positive electrode active material layers 121 and 122 may optionally further include an additive such as a binder or a conductive agent.

For example, the positive electrode active material is not particularly limited as long as it can secure sufficient capacity of the all-solid-state battery 100. For example, positive electrode active material may include lithium cobalt oxide, lithium nickel cobalt manganese oxide, lithium nickel cobalt aluminum oxide, lithium iron phosphate, lithium manganese oxide, or a combination thereof.

For example, the positive electrode active material may be compounds represented by the following chemical formulas: LiₐA_{1-b}M_{b}D₂ (wherein 0.90≤a≤1.8, 0≤b≤0.5); LiₐE_{1-b}M_{b}O_{2-c}D_{c} (wherein 0.90≤a≤1.8, 0≤b≤0.5, 0≤c≤0.05); LiE_{2-b}M_{b}O_{4-c}D_{c} (wherein 0≤b≤0.5, 0≤c≤0.05); LiₐNi_{1-b-c}Co_{b}M_{c}D_{α} (wherein 0.90≤a≤1.8, 0≤b≤0.5, 0≤c≤0.05, 0<α≤2); LiₐNi_{1-b-c}Co_{b}M_{c}O_{2-α}X_{α} (wherein 0.90≤a≤1.8, 0≤b≤0.5, 0≤c≤0.05, 0<α<2); LiₐNi_{1-b|c}CO_{b}M_{c}O_{2-α}X₂ (wherein 0.90≤a≤1.8, 0≤b≤0.5, 0≤c≤0.05, 0<α<2); LiₐNi_{1-b-c}Mn_{b}M_{c}D_{α} (wherein 0.90≤a≤1.8, 0≤b≤0.5, 0≤c≤0.05, 0<α≤2); LiₐNi_{1-b-c}Mn_{b}M_{c}O_{2-α}X_{α} (wherein 0.90≤a≤1.8, 0≤b≤0.5, 0≤c≤0.05, 0<α≤2); LiₐNi_{1-b-c}Mn_{b}M_{c}O_{2-α}X₂ (wherein 0.90≤a≤1.8, 0≤b≤0.5, 0≤c≤0.05, 0<α<2); LiₐNi_{b}Co_{c}Mn_{d}GaO₂ (wherein 0.90≤a≤1.8, 0≤b≤0.9, 0≤c≤0.5, 0.001≤d≤0.1); LiₐNi_{b}Co_{c}Mn₄GeO₂ (wherein 0.90≤a≤1.8, 0≤b≤0.9, 0≤c≤0.5, 0≤d≤0.5, 0.001≤e≤0.1); LiₐNiGbO₂ (wherein 0.90≤a≤1.8, 0.001≤b≤0.1); LiₐCoGbO₂ (wherein 0.90≤a≤1.8, 0.001≤b≤0.1); LiₐMnGbO₂ (wherein 0.90≤a≤1.8, 0.001≤b≤0.1); LiₐMn₂GbO₄ (wherein 0.90≤a≤1.8, 0.001≤b≤0.1); QO₂; QS₂; LiQS₂; V₂O₅; LiV₂O₂; LiRO₂; LiNiVO₄; Li_{(3-f)}J₂(PO₄)₃ (0≤f≤2); Li_{(3-f)}Fe₂(PO₄)₃ (wherein 0≤f≤2); and LiFePO₄, wherein in the above chemical formulas, A is Ni, Co, or Mn; M is Al, Ni, Co, Mn, Cr, Fe, Mg, Sr, V, or a rare-earth element; D is O, F, S, or P; E is Co or Mn; X is F, S, or P; G is Al, Cr, Mn, Fe, Mg, La, Ce, Sr, or V; Q is Ti, Mo, or Mn; R is Cr, V, Fe, Sc, or Y; and J is V, Cr, Mn, Co, Ni, or Cu.

The positive electrode active material may also be LiCoO₂, LiMnₓO₂ₓ (wherein x=1 or 2), LiNi₁₋ₓMnO₂O₂ₓ (wherein 0<x<1), LiNi_{1-x-y}CoₓMn_{y}O₂ (wherein 0≤x≤0.5, 0≤y≤0.5), LiFePO₄, TiS₂, FeS₂, TiS₃, or FeS₃.

As the solid electrolyte, a solid electrolyte usable in the solid electrolyte layer 130, which are described later, may be used. The solid electrolyte may function as an ion conduction channel in the positive electrode layer 120, and through this, interface resistance may be reduced.

A content of the solid electrolyte may be greater than or equal to 0.1 parts by weight, greater than or equal to 1 part by weight, or greater than or equal to 10 parts by weight, and less than or equal to 80 parts by weight, less than or equal to 60 parts by weight, or less than or equal to 50 parts by weight based on 100 parts by weight of the total amount of the positive electrode active material.

The conductive agent is not particularly limited as long as it has conductivity without causing chemical change in the all-solid-state battery 100. For example, examples of the conductive agent may include graphite such as natural graphite and artificial graphite; carbon-based substances such as carbon black, acetylene black, ketjen black, channel black, furnace black, lamp black, and summer black; conductive fibers such as carbon fibers and metal fibers; fluorinated carbon; metal powders such as aluminum and nickel powder, conductive whiskers such as zinc oxide and potassium titanate; conductive metal oxides such as titanium oxide; or conductive materials such as polyphenylene derivatives.

A content of the conductive agent may be 1 part by weight to 10 parts by weight, or for example, 2 parts by weight to 5 parts by weight, based on 100 parts by weight of the positive electrode active material. When the content of the conductive agent is within the above range, a finally obtained electrode may have excellent conductivity characteristics.

The binder may be used to improve bonding strength between an active material and a conductive agent. The binder may include polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, an ethylene-propylene-diene terpolymer (EPDM), sulfonated EPDM, a styrene butadiene rubber, a fluororubber, acryl, or various copolymers, and the like.

A content of the binder may be 1 part by weight to 50 parts by weight, or for example, 2 parts by weight to 5 parts by weight, based on 100 parts by weight of the total positive electrode active material. When the content of the binder satisfies the above range, the active material layer may have high bonding strength.

As the positive electrode current collector 123, a porous material such as a mesh or mesh shape may be used, and a porous metal plate such as stainless steel, nickel, or aluminum may be used. In addition, the positive electrode current collector 123 may be coated with an oxidation-resistant metal or alloy film to prevent oxidation.

The negative electrode active material layers 141 and 142 may include a negative electrode active material and, optionally, a solid electrolyte. In addition, the negative electrode active material layers 141 and 142 may optionally further include an additive such as a binder or a conductive agent.

The negative electrode active material may be a carbon-based material, silicon, a silicon oxide, a silicon-based alloy, a silicon-carbon-based material composite, tin, a tin-based alloy, a tin-carbon composite, a metal oxide, or a combination thereof, and may include a lithium metal and/or a lithium metal alloy.

The lithium metal alloy may include lithium and a metal/semi-metal capable of alloying with lithium. For example, the metal/semi-metal capable of alloying with lithium may include Si, Sn, Al, Ge, Pb, Bi, Sb, a Si—Y alloy (wherein Y is an alkali metal, an alkaline-earth metal, Group 13 to Group 16 elements, a transition metal, a rare earth element, or a combination thereof, and Si is not included), a Sn—Y alloy (wherein Y is an alkali metal, an alkaline earth metal, Group 13 to Group 16 elements, a transition metal, a transition metal oxide such as lithium titanium oxide (Li₄Ti₅O₁₂), a rare earth element, or a combination thereof, and Sn is not included), or MnOₓ (0<x≤2).

The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

In addition, the oxide of a metal/semi-metal capable of alloying with lithium may be lithium titanium oxide, vanadium oxide, lithium vanadium oxide, SnO₂, SiOₓ (0<x<2), and the like. For example, the negative electrode active material may include one or more elements selected from elements of Groups 13 to 16 of the periodic table of elements. For example, the negative electrode active material may include one or more elements selected from the group consisting of Si, Ge, and Sn.

The carbon-based material may be crystalline carbon, amorphous carbon, or a mixture thereof. The crystalline carbon may include graphite, such as natural graphite or artificial graphite in irregular, plate, flake, spherical, or fibrous form. In addition, the amorphous carbon may include soft carbon (low temperature calcined carbon) or hard carbon, a mesophase pitch carbonization product, calcined coke, graphene, carbon black, fullerene soot, a carbon nanotube, a carbon fiber, and the like.

The silicon may be Si, SiOₓ (0<x<2, for example 0.5 to 1.5), Sn, SnO₂, a silicon-containing metal alloy, or a mixture thereof. The silicon-containing metal alloy may include, for example, silicon and one or more of Al, Sn, Ag, Fe, Bi, Mg, Zn, in, Ge, Pb, and Ti.

As the solid electrolyte, a solid electrolyte usable in the solid electrolyte layer 130, which are described later, may be used. The solid electrolyte may function as an ion conduction channel in the negative electrode layer 140, and through this, interface resistance may be reduced.

A content of the solid electrolyte may be greater than or equal to 0.1 parts by weight, greater than or equal to 1 part by weight, or greater than or equal to 10 parts by weight, and less than or equal to 80 parts by weight, less than or equal to 60 parts by weight, or less than or equal to 50 parts by weight based on 100 parts by weight of the total amount of the negative electrode active material.

The negative electrode active material layers 141 and 142 may also optionally include a conductive agent and a binder as described for the positive electrode active material layers 121 and 122.

As the negative electrode current collector 143, a porous material such as a mesh or mesh shape may be used, and a porous metal plate such as stainless steel, nickel, or aluminum may be used. In addition, the negative electrode current collector 143 may be coated with an oxidation-resistant metal or alloy film to prevent oxidation.

The solid electrolyte layer 130 may be disposed and stacked between the positive electrode layer 120 and the negative electrode layer 140. Accordingly, the solid electrolyte layer 130 may be adjacently disposed between the positive electrode active material layers 121 and 122 of the positive electrode layer 120 and the negative electrode active material layers 141 and 142 of the negative electrode layer 140 in the stacking direction.

Therefore, in the all-solid-state battery 100, a plurality of positive electrode layers 120 and a plurality of negative electrode layers 140 may be alternately disposed, and a plurality of solid electrolyte layers 130 may be interposed and stacked therebetween. In the all-solid-state battery 100, a plurality of positive electrode layers 120 and negative electrode layers 140 are alternately stacked, and a plurality of solid electrolyte layers 130 are interposed therebetween to manufacture a cell stack, and then the cell stack may be batch-fired to manufacture a stacked all-solid-state battery 100.

Referring to FIG. 2, in an embodiment, the solid electrolyte layer 130 includes a first electrolyte layer 131 and a second electrolyte layer 132 disposed on one surface or both surfaces of the first electrolyte layer 131.

For example, the second electrolyte layer 132 may be disposed between the electrode layers 120 and 140 and the first electrolyte layer 131, for example, the second electrolyte layer 132 may be disposed between the positive electrode layer 120 and/or negative electrode layer 140 and the first electrolyte layer 131.

For example, the second electrolyte layer 132 may be disposed to contact the positive electrode active material layers 121 and 122, and the second electrolyte layer 132 may be disposed to contact the negative electrode active material layers 141 and 142. In other words, the second electrolyte layer 132 may directly contact the electrode active material layers 121, 122, 141, and 142, and the first electrolyte layer 131 may not directly contact electrode active material layers 121, 122, 141, and 142 but between the second electrolyte layers 132.

Referring to FIG. 3, the solid electrolyte layer 130 according to another embodiment includes the first electrolyte layer 131; and the second electrolyte layer 132 disposed on one surface of the first electrolyte layer 131.

For example, the first electrolyte layer 131 is disposed between the negative electrode layer 140 and the second electrolyte layer 132, and the second electrolyte layer 132 may be disposed between the positive electrode layer 120 and the first electrolyte layer 131.

For example, the second electrolyte layer 132 may be disposed to contact the positive electrode active material layers 121 and 122, and the first electrolyte layer 131 may be disposed to contact the negative electrode active material layers 141 and 142. In other words, the first electrolyte layer 131 may directly contact the negative electrode active material layers 141 and 142, and the second electrolyte layer 132 may directly contact the positive electrode active material layers 121 and 122.

In an embodiment, the first electrolyte layer 131 may have an average thickness of 5 to 30 μm, for example, 10 to 30 μm, or 15 to 20 μm.

The average thickness of the second electrolyte layer 132 may be 1 to 10 μm, for example, 2 to 7 μm, or 2 to 5 μm.

in an embodiment, a ratio of the average thickness of the first electrolyte layer 131 and the average thickness of the second electrolyte layer 132 may be 1:1 to 15:1, for example, 3:1 to 10:1, or 3:1 to 7:1.

When the average thicknesses of the first electrolyte layer 131 and the second electrolyte layer 132 satisfy the ranges, an all-solid-state battery with excellent ionic conductivity as well as excellent interfacial stability may be realized.

The average thicknesses of the first electrolyte layer 131 and the second electrolyte layer 132 may be measured in the following method. Each cross-section of the first electrolyte layer 131 and the second electrolyte layer 132 is obtained by ion milling and the like, and a scanning electron microscope (SEM) photograph thereof is taken. Subsequently, in the cross-section SEM photograph, ten points are randomly selected and measured with respect to a thickness of each layer, and the measurements are calculated into an arithmetic mean, which is obtained as each average thickness of the first electrolyte layer 131 and the second electrolyte layer 132.

The solid electrolyte layer 130 may include an inorganic solid electrolyte including an oxide-type solid electrolyte, a sulfide-type solid electrolyte, or a combination thereof.

The oxide-type solid electrolyte may be a Garnet-type, NASICON-type, LISICON-type, perovskite-type, LiPON-type, or amorphous (glass) electrolyte.

The garnet-type solid electrolyte may include lithium-lanthanum zirconium oxide (LLZO) represented by LiₐLa_{b}Zr_{c}O₁₂ such as Li₇La₃Zr₂O₁₂, and the NASICON-type solid electrolyte may include a lithium-aluminum-titanium-phosphate salt (LATP) of Li₁₊ₓAlₓTi₂₋ₓ(PO₄)₃ (0<x<1) in which Ti is introduced into a Li₁₊ₓAlₓM₂₋ₓ(PO₄)₃ (LAMP) (0<x<2, M is Zr, Ti, or Ge) type compound, lithium-aluminum-germanium-phosphate (LAGP) represented by Li₁₊ₓAlₓGe₂₋ₓ(PO₄)₃ (0<x<1) such as Li_{1.3}Al_{0.3}Ti_{1.7}(PO₄)₃ introduced with excess lithium and/or lithium-zirconium-phosphate (LZP) of LiZr₂(PO₄)₃.

In addition, the LISICON-type solid electrolyte may be include a solid solution oxide represented by xLi₃AO₄-(1−x)Li₄BO₄ (wherein A is P, As, or V and B is Si, Ge, or Ti) such as Li₄Zn(GeO₄)₄, Li₁₀GeP₂O₁₂ (LGPO), Li_{3.5}Si_{0.5}P_{0.5}O₄, or Li_{10.42}Si(Ge)_{1.5}P_{1.5}Cl_{0.08}O_{11.92}, or a solid solution sulfide represented by Li₄₋ₓM_{1-y}M′_{y}S₄ (wherein M is Si, or Ge and M′ is P, Al, Zn, or Ga) such as Li₂S—P₂S₅, Li₂S—SiS₂, Li₂S—SiS₂—P₂S₅, or Li₂S—GeS₂.

The perovskite-type solid electrolyte may include lithium lanthanum titanate (LLTO) represented by Li₃ₓLa_{2/3-x}□_{1/3·2x}TiO₃ (0<x<0.16, □: vacancy) such as Li_{1/8}La_{5/8}TiO₃. The LiPON-type solid electrolyte may include a lithium phosphorous oxynitride such as Li_{2.8}PO_{3.3}N_{0.46}.

Examples of the amorphous electrolyte include Li₂O—B₂O₃—SiO₂, Li₂O—B₂O₃—P₂O₅, Li₃BO₃—Li₂SO₄, or Li₃BO₃—Li₂CO₃.

The lithium ionic conductivity of the oxide-type solid electrolyte included in the solid electrolyte layer 130 may be greater than or equal to 1×10⁻⁵ S/cm. The ionic conductivity may be measured at a temperature of 25° C. The ionic conductivity may be greater than or equal to 1×10⁻⁵ S/cm, greater than or equal to 2×10⁻⁵ S/cm, greater than or equal to 3×10⁻⁵ S/cm, greater than or equal to 4×10⁻⁵ S/cm, or greater than or equal to 5×10⁻⁵ S/cm, of which an upper limit is not particularly limited. When a solid electrolyte satisfying the ranges of ionic conductivity is used, the all-solid-state battery 100 may exhibit high power.

FIG. 4 is an ion milling cross-section scanning microscope (SEM) photograph of a first electrolyte layer (top) and a second electrolyte layer (bottom).

In an embodiment, the first electrolyte layer 131 includes a glass-ceramic electrolyte including lithium chloride (LiCl), and the second electrolyte layer 132 includes lithium borosilicate (LBSO)-based electrolyte.

The first electrolyte layer 131 includes a glass-ceramic electrolyte including lithium chloride (LiCl). A glass-ceramic (or crystallized glass) means that in the X-ray diffraction or an electron beam diffraction, etc., a peak and a halo are observed, which shows that amorphous and crystalline crystallographically coexist. Accordingly, the glass-ceramic electrolyte is partially crystallized through the firing and in a state that the amorphous and the crystalline are mixed.

When the glass-ceramic electrolyte is included, densification is sufficiently secured after the firing, realizing high ionic conductivity. On the contrary, when the glass-ceramic electrolyte is disposed on the interface with an electrode, the glass-ceramic electrolyte may react with the electrode and form a secondary phase, and there may occur a short circuit due to interlayer movement of an electrode material.

Referring to FIG. 2, in an embodiment, the first electrolyte layer 131 including the glass-ceramic electrolyte is disposed between the second electrolyte layers 132 not to directly contact the electrode active material layers 121, 122, 141, and 142, improving interfacial stability and achieving excellent ionic conductivity.

Referring to FIG. 3, in another example embodiment, the first electrolyte layer 131 including the glass-ceramic electrolyte may be disposed to directly contact the negative electrode active material layers 141, and 142 alone but not to directly contact the positive electrode active material layers 121 and 122. In other words, when the positive electrode active material layers directly contact the solid electrolyte layer, since lithium ions are diffused from the solid electrolyte layer to the positive electrode active material layers and cause a larger interface reaction than at the negative electrode, the first electrolyte layer 131 including the glass-ceramic electrolyte may be introduced only onto the interface contacting the negative electrode.

The glass-ceramic electrolyte may include lithium (Li) oxide, boron (B) oxide, silicon (Si) oxide, phosphorus (P) oxide, germanium (Ge) oxide, and the lithium chloride (LiCl).

As a specific example, the glass-ceramic electrolyte may include Li₂O—B₂O₃—SiO₂—P₂O₅—GeO₂—LiCl. For example, the glass-ceramic electrolyte may include a crystal phase of lithium chloroboracite.

The lithium oxide (Li₂O) may be included in an amount of 35 to 55 mol %, for example, 40 to 50 mol %, based on the total amount of the glass-ceramic electrolyte. When the content of lithium oxide is less than 35 mol %, lithium ionic conductivity may be low, and when it exceeds 55 mol %, vitrification may be difficult and deliquescence may be deteriorated.

The born oxide (B₂O₃) may be included in an amount of 30 to 50 mol % based on a total amount of the glass-ceramic electrolyte, for example, 30 to 40 mol %. When the content of the boron oxide is less than 30 mol %, ionic conductivity may be deteriorated, but when greater than 50 mol %, the all-solid-state battery may be vulnerable to exposure to a high humidity environment.

The silicon oxide (SiO₂) may be included in an amount of 5 to 15 mol % based on the total amount of the glass-ceramic electrolyte, for example, 10 to 15 mol %. When the content of the silicon oxide is less than 5 mol %, the all-solid-state battery may be vulnerable to exposure to a high humidity environment, but when greater than 15 mol %, the ionic conductivity may be deteriorated.

The phosphorus oxide (P₂O₅) may be included in an amount of 0.1 to 5 mol % based on the total amount of the glass-ceramic electrolyte, for example, 0.5 to 2.5 mol %. When the content of the phosphorus oxide is less than 0.1 mol %, material density may be lowered, but when greater than 5 mol %, the ionic conductivity may be deteriorated.

The germanium oxide (GeO₂) may be included in an amount of 0.1 to 5 mol % based on the total amount of the glass-ceramic electrolyte, for example, 1 to 5 mol %. When the content of the germanium oxide is less than 0.1 mol %, the material density may be lowered, but when greater than, 5 mol %, the ionic conductivity may be deteriorated.

The lithium chloride (LiCl) may be included in an amount of 0.5 to 10 mol % based on the total amount of the glass-ceramic electrolyte, for example, 2 to 8 mol %. When the content of the lithium chloride is less than 0.5 mol %, the lithium ionic conductivity may be deteriorated, but when the content is 10 mol %, deliquescence may be deteriorated.

The content of each of the above components is the content of each constituent in the glass-ceramic electrolyte, for example, expressed by a ratio of content (mol) of each constituent to a total amount (mols) of lithium (Li) oxide, boron (B) oxide, silicon (Si) oxide, phosphorus (P) oxide, germanium (Ge) oxide, and lithium chloride (LiCl) as a percentage (mol %). The content of each component may be measured by using inductively coupled plasma emission spectrometry (ICP-AES) or the like.

The second electrolyte layer 132 includes a lithium borosilicate-based electrolyte (hereinafter. LBSO-type solid electrolyte). The LBSO-type solid electrolyte is an electrolyte in a glass state, and the glass is crystalligraphically amorphous in which a halo is observed in the X-ray diffraction or the electron beam diffraction, etc.

When the LBSO-type solid electrolyte is included, since a firing temperature may not only be lowered, but also the amorphous state may be maintained during the firing, there are advantages of realizing high ionic conductivity but having no high reactivity with electrodes. However, under the firing conditions maintaining the amorphous state, since the densification is not sufficiently secured, there is a problem that it is difficult to increase the ionic conductivity.

Referring to FIG. 2, in an embodiment, the second electrolyte layer 132 including the LBSO-type solid electrolyte may be disposed to directly contact the electrode active material layers 121, 122, 141, and 142 to secure interfacial stability. In addition, as described above, the aforementioned problem may be solved by disposing the first electrolyte layer 131 sufficiently densified and capable of realizing high ionic conductivity between the second electrolyte layers 132.

Referring to FIG. 3, in another example embodiment, the second electrolyte layer 132 including the LBSO-type solid electrolyte is disposed to directly contact the positive electrode active material layers 121 and 122 alone but not to directly contact the negative electrode active material layers 141 and 142. In other words, when the positive electrode active material layers and the solid electrolyte layer are in direct contact with each other, since lithium ions are diffused from the solid electrolyte layer to the positive electrode active material layers and have a larger interface reaction than at the negative electrode, the second electrolyte layer 132 including the LBSO-type solid electrolyte may be introduced only onto the interface contacting the positive electrode.

The LBSO-type solid electrolyte may include lithium (Li) oxide, silicon (Si) oxide, and boron (B) oxide. For example, the LBSO-type solid electrolyte may include Li₂ O—SiO₂—B₂O₃.

The lithium oxide (Li₂O) may be included in an amount of 35 to 65 mol %, for example, 40 to 60 mol % or 45 to 55 mol % based on the total amount of the LBSO-type solid electrolyte. When the content of lithium oxide is less than 35 mol %, lithium ionic conductivity may be low, and when it exceeds 65 mol %, vitrification may be difficult and deliquescence may be deteriorated.

The silicon oxide (SiO₂) may be included in an amount of 5 to 25 mol % based on a total amount of the LBSO-type solid electrolyte, for example, 10 to 20 mol %. When the content of the silicon oxide is less than 5 mol %, the all-solid-state battery may be vulnerable to exposure to a high humidity environment, but when greater than 25 mol %, the ionic conductivity may be deteriorated.

The boron oxide (B₂O₃) is included in an amount of 30 to 50 mol % based on the total amount of the LBSO-type solid electrolyte, for example, 30 to 40 mol %. When the content of the boron oxide is less than 30 mol %, the ionic conductivity may be deteriorated, but when greater than 50 mol %, the all-solid-state battery may be vulnerable to exposure to a high humidity environment.

Optionally, the LBSO-type solid electrolyte further include additional oxide including Na (sodium), Mg (magnesium), Al (aluminum), P (phosphorus), K (potassium), Ca (calcium), Ti (titanium), V (vanadium), Cr (chromium), Mn (manganese), Fe (iron), Co (cobalt), Ni (nickel), Cu (copper), Zn (zinc), Ga (gallium), Ge (germanium), Se (selenium), Rb (rubidium), S (sulfur), Y (yttrium), Zr (zirconium), Nb (niobium), Mo (molybdenum), Ag (silver), In (indium), Sn (tin), Sb (antimony), Cs (cesium), Ba (vanadium), Hf (hafnium), Ta (tantalum), W (tungsten), Pb (lead), Bi (bismuth), Au (gold), La (lanthanum), Nd (neodymium), Eu (europium), or a combination thereof.

In this case, when an additional oxide is further included, it may be included in an amount of 0 to 10 mol % based on the total amount of the LBSO-type solid electrolyte.

The LBSO-type solid electrolyte may further include an additive, and the additive may include LiF, LiCl, LiBr, LiI, Li₃N, LiPON, Li₂C₂O₄, Li₂CO₃, LiAlCl₄, Li₂O, Li₂S, LiSO₄, Li₂SO₄, Li₃PO₄, Li₃VO₄, Li₄GeO₄, Li₂Si₂O₅, Li₂SiO₃, Li₄SiO₄, Li₄ZrO₄, LiMoO₄, LiAlF₄, Li₃Ni₂, LiBF₄, LiCF₃SO₃, or a combination thereof, and LiCl or LiSO₄ may be included in terms of implementing high ionic conductivity.

The solid electrolyte layer 130 may have lithium ionic conductivity of greater than or equal to 1×10⁻⁶ S/cm in terms of improving the performance of the all-solid-state battery 100. The ionic conductivity may be measured at a temperature of 25° C. The ionic conductivity may be greater than or equal to 1×10⁻⁶ S/cm, greater than or equal to 2×10⁻⁶ S/cm, greater than or equal to 3×10⁻⁶ S/cm, greater than or equal to 4×10⁻⁶ S/cm, or greater than or equal to 5×10⁻⁶ S/cm, of which an upper limit is not particularly limited.

Lithium (Li) ionic conductivity of the solid electrolyte layer 130 may be measured by an alternating current (AC) impedance method. First, a portion of the solid electrolyte layer 130 in the all-solid-state battery 100 is sampled as a rectangular plate-shaped piece by ion milling or polishing. Subsequently, electrodes made of gold (Au) are formed on both ends of the obtained piece to prepare a sample. Then, the sample is measured for alternating current impedance (frequency: 10⁻⁶ Hz to 10⁻¹ Hz, voltage: 100 mV, 1000 mV) at room temperature (25° C.) using an impedance measurement device to calculate the ionic conductivity.

In an embodiment, a margin layer 150 may be disposed along edges of the positive electrode layer 120 and the negative electrode layer 140. The margin layer 150 is disposed on the solid electrolyte layer 130 and may be formed laterally adjacent to edges of the positive electrode active material layers 121 and 122 or the negative electrode active material layers 141 and 142. Accordingly, the margin layer 150 may be disposed on the same layer as the positive electrode layer 120 and the negative electrode layer 140.

The margin layer 150 may include an insulating material having an ionic conductivity of less than or equal to 1.0×10⁻¹⁰ S/cm or less than or equal to 1.0×10⁻⁶ S/cm, for example, an insulating material such as the aforementioned solid electrolyte material, ceramic, or resin.

For example, the ceramic may include alumina (Al₂O₃), aluminum nitride (AlN), beryllium oxide (BeO), boron nitride (BN), silicon (Si), silicon carbide (SiC), silica (SiO₂), and silicon nitride (Si₃N₄), gallium arsenide (GaAs), gallium nitride (GaN), barium titanate (BaTiO₃), zirconium dioxide (ZrO₂), a mixture thereof, an oxide and/or a nitride of these materials.

For example, the resin may be a polyolefin such as polyethylene or polypropylene and the like, a polyester such as polyethylene terephthalate (PET) and the like, polyurethane, or polyimide.

In addition, the margin layer 150 may include an inorganic solid electrolyte including an oxide-type solid electrolyte used in the solid electrolyte layer 130, a sulfide-type solid electrolyte, or a combination thereof. However, the margin layer 150 are not limited thereto but may include various materials.

The positive electrode layer 120, the solid electrolyte layer 130, the negative electrode layer 140, and the margin layer 150 may be stacked as described above to form a cell stack of the all-solid-state battery 100. Cover layers 160 may be further disposed on upper and lower ends of the cell stack of the all-solid-state battery 100.

For example, the cover layer 160 may be disposed on outer surfaces of an uppermost electrode layer and a lowermost electrode layer in the stacking direction of the cell stack. At this time, a solid electrolyte layer may be disposed between the cover layer and the electrode layer adjacent thereto.

The cover layer 160 may include, for example, the same material as the margin layer 150 in order to impart insulating and moisture-proof functions to the all-solid-state battery 100, and may include, for example, an insulating material such as the aforementioned solid electrolyte material, ceramic, or resin. Since this has been described above, a detailed description thereof will be omitted.

In addition, terminals of the positive current collector 123 and terminals of the negative current collector 143 are exposed on both sides of the cell stuck of the all-solid-state battery 100, and external electrodes 112 and 114 may be connected to and coupled to the exposed terminals. That is, the external electrodes 112 and 114 may be configured to be connected to terminals of the positive current collector 123 to have positive properties, and connected to terminals of negative current collector 143 to have negative properties. When the terminals of the positive current collector 123 and the terminals of the negative current collector 143 are configured to face in opposite directions, the external electrodes 112 and 114 may also be disposed on both sides, respectively.

The external electrodes 112 and 114 may include a conductive metal and glass.

The conductive metal may include, for example, copper (Cu), nickel (Ni), tin (Sn), palladium (Pd), platinum (Pt), gold (Au), silver (Ag), tungsten (W), titanium (Ti), lead (Pb), or an alloy thereof.

A glass component included in the external electrodes 112 and 114 may have a composition in which an oxide is mixed. The glass component may include, for example, a silicon oxide, a boron oxide, an aluminum oxide, a transition metal oxide, an alkali metal oxide, an alkaline-earth metal oxide, or a combination thereof. Herein, the transition metal may be selected from zinc (Zn), titanium (Ti), copper (Cu), vanadium (V), manganese (Mn), iron (Fe), or nickel (Ni), the alkali metal may be selected from lithium (Li), sodium (Na), or potassium (K), and the alkaline-earth metal may be selected from magnesium (Mg), calcium (Ca), strontium (Sr), or barium (Ba).

A method of forming the external electrodes 112 and 114 is not particularly limited. For example, the method may include dipping the cell stack in a conductive paste including a conductive metal and glass or screen-printing or gravure-printing the conductive paste on the surface of the cell stack. In addition, various methods of applying the conductive paste on the surface of the cell stack or transferring a dry film obtained by drying the conductive paste onto the cell stack may be used.

A stacked all-solid-state battery according to an embodiment includes a cell stack including a plurality of solid electrolyte layers and a plurality of positive electrode layers and negative electrode layers alternately disposed with the plurality of solid electrolyte layers interposed therebetween, and first and second external electrodes disposed laterally adjacent to the cell stack and connected to the plurality of positive electrode layers and the plurality of negative electrode layers, respectively, wherein the solid electrolyte layers may include first electrolyte layers including a glass-ceramic electrolyte including lithium chloride (LiCl); and second electrolyte layers disposed on one surface or both surfaces of the first electrolyte layer and including a lithium borosilicate-based electrolyte.

A stacked all-solid-state battery according to another embodiment includes a cell stack including a plurality of solid electrolyte layers and a plurality of positive electrode layers and negative electrode layers alternately disposed with the plurality of solid electrolyte layers interposed therebetween, and first and second external electrodes disposed laterally adjacent to the cell stack and connected to the plurality of positive electrode layers and the plurality of negative electrode layers, respectively, wherein the solid electrolyte layers may include first electrolyte layers including a glass-ceramic electrolyte including lithium chloride (LiCl); and second electrolyte layers disposed on one surface of the first electrolyte layer and including a lithium borosilicate (LBSO)-based electrolyte, the first electrolyte layers are disposed between the negative electrode layers and the second electrolyte layer, and the second electrolyte layers are disposed between the positive electrode layers and the first electrolyte layer.

Hereinafter, specific examples of the present disclosure are presented. However, the examples described below are only intended to specifically illustrate or explain the inventive concepts of the disclosure, and the scope of the disclosure should not be limited thereto.

### Example 1

A first electrolyte layer green sheet is manufactured to include 43 mol % of Li₂O, 37 mol % of B₂O₃, 11 mol % of SiO₂, 1 mol % of P₂O₅, 3 mol % of GeO₂, and 5 mol % of LiCl.

A second electrolyte layer green sheet is also manufactured to include 50 mol % of Li₂O, 17 mol % of SiO₂, and 33 mol % of B₂O₃.

From the bottom, [positive electrode layer green sheet-second electrolyte layer green sheet-first electrolyte layer green sheet-second electrolyte layer green sheet-negative electrode layer green sheet] are stacked in order and then, tired at 510° C., manufacturing a unit cell.

### Example 2

A unit cell is manufactured in the same manner as in Example 1 except that [positive electrode layer green sheet-second electrolyte layer green sheet-first electrolyte layer green sheet-negative electrode layer green sheet-first electrolyte layer green sheet-second electrolyte layer green sheet-positive electrode layer green sheet] in order from the bottom are stacked.

### Comparative Example 1: Single LBSO Electrolyte Layer

A unit cell is manufactured in the same manner as in Example 1 except that [positive electrode layer green sheet-second electrolyte layer green sheet-negative electrode layer green sheet] in order from the bottom are stacked.

### Comparative Example 2: Single LCB Electrolyte Layer

A unit cell is manufactured in the same manner as in Example 1 except that [positive electrode layer green sheet-first electrolyte layer green sheet-negative electrode layer green sheet] in order from the bottom are stacked.

### Experimental Example: Room-Temperature Lithium Ionic Conductivity Analysis

Each unit cell of Examples 1 to 2 and Comparative Examples 1 to 2 is ion-milled to sample a portion of each solid electrolyte layer into a rectangular plate piece. At both ends of the piece, an electrode made of gold (Au) is formed, preparing a sample. Subsequently, the sample is measured with respect to AC impedance by using an impedance measuring device (frequency: 10⁺⁶ Hz to 10⁻¹ Hz, voltage: 100 mV, 1000 mV) at room temperature (25° C.) to calculate ionic conductivity. The calculated results are shown in Table 1.

TABLE 1

| | Room-temperature (25° C.) ionic conductivity (S/cm) |
|---|---|
| Example 1 | 6.64E−06 |
| Example 2 | 3.54E−06 |
| Comparative | 9.84E−09 |
| Example 1 | |
| Comparative | 7.43E−07 |
| Example 2 | |

Referring to Table 1, the examples maintain an amorphous state during the firing and thus realize high ionic conductivity, wherein the unit cells have ionic conductivity of E-06 (S/cm) or higher by disposing a second electrolyte layer having no high reactivity with electrodes on the interface with an electrode layer (Example 1) or on the interface with a positive electrode layer (Example 2) but disposing a first electrolyte layer having high reactivity with the interface not to face the electrode layer (Example 1) or to face the negative electrode layer alone (Example 2). On the other hand, the comparative examples include a solid electrolyte layer composed of a single layer and thus exhibit low ionic conductivity (Comparative Example 1) due to insufficient densification or also, low ionic conductivity (Comparative Example 2) due to a secondary phase produced through a reaction with an electrode interface.

While the inventive concepts of the present disclosure have been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims.

### INDUSTRIAL APPLICABILITY

The present disclosure relates to an all-solid-state battery with excellent interfacial stability between an electrode and a solid electrolyte, excellent ionic conductivity by achieving densification, which can be used in various electrochemical devices and electronic devices.

### DESCRIPTION OF SYMBOLS

100: all-solid-state battery
112, 114: external electrode
120: positive electrode layer
121, 122: positive electrode active material layer
123: positive electrode current collector
130: solid electrolyte layer
131: first electrolyte layer
132: second electrolyte layer
140: negative electrode layer
141, 142: negative electrode active material layer
143: negative electrode current collector
150: margin layer
160: cover layer

1. An all-solid-state battery, comprising
a positive electrode layer and a negative electrode layer, and a solid electrolyte layer interposed between the positive electrode layer and the negative electrode layer,
wherein the solid electrolyte layer comprises a first electrolyte layer including a glass-ceramic electrolyte including lithium chloride (LiCl);
and a second electrolyte layer disposed on one surface or both surfaces of the first electrolyte layer and including a lithium borosilicate-based electrolyte.

2. The all-solid-state battery of claim 1, wherein
the second electrolyte layer is disposed between the positive electrode layer or the negative electrode layer and the first electrolyte layer.

3. The all-solid-state battery of claim 1, wherein
the glass-ceramic electrolyte further includes a lithium chloroboracite crystal.

4. The all-solid-state battery of claim 1, wherein
the glass-ceramic electrolyte further includes lithium (Li) oxide, boron (B) oxide, silicon (Si) oxide, phosphorus (P) oxide, and germanium (Ge) oxide.

5. The all-solid-state battery of claim 4, wherein
the glass-ceramic electrolyte includes 35 to 55 mol % of lithium (Li) oxide, 30 to 50 mol % of boron (B) oxide, 5 to 15 mol % of silicon (Si) oxide, 0.1 to 5 mol % of phosphorus (P) oxide, 0.1 to 5 mol % of germanium (Ge) oxide, and 0.5 to 10 mol % of lithium chloride based on a total amount of the glass-ceramic electrolyte.

6. The all-solid-state battery of claim 1, wherein
the lithium borosilicate-based electrolyte includes lithium (Li) oxide, silicon (Si) oxide, and boron (B) oxide.

7. The all-solid-state battery of claim 6, wherein
the lithium borosilicate-based electrolyte includes 35 to 65 mol % of lithium (Li) oxide, 5 to 25 mol % of silicon (Si) oxide, and 30 to 50 mol % of boron (B) oxide based on a total amount of the lithium borosilicate-based electrolyte.

8. The all-solid-state battery of claim 6, wherein
the lithium borosilicate-based electrolyte further includes additional oxide including Na (sodium), Mg (magnesium), Al (aluminum), P (phosphorus), K (potassium), Ca (calcium), Ti (titanium), V (vanadium), Cr (chromium), Mn (manganese), Fe (iron), Co (cobalt), Ni (nickel), Cu (copper), Zn (zinc), Ga (gallium), Ge (germanium), Sc (selenium), Rb (rubidium), S (sulfur), Y (yttrium), Zr (zirconium), Nb (niobium), Mo (molybdenum), Ag (silver), In (indium), Sn (tin), Sb (antimony), Cs (cesium), Ba (vanadium), Hf (hafnium), Ta (tantalum), W (tungsten), Pb (lead), Bi (bismuth), Au (gold), La (lanthanum), Nd (neodymium), Eu (europium), or a combination thereof.

9. The all-solid-state battery of claim 6, wherein
the lithium borosilicate-based electrolyte further includes an additive, which includes LiF, LiCl, LiBr, LiI, Li₃N, LiPON, Li₂C₂O₄, Li₂CO₃, LiAlCl₄, Li₂O, Li₂S, LiSO₄, Li₂SO₄, Li₃PO₄, Li₃VO₄, Li₄GeO₄, Li₂Si₂O₅, Li₂SiO₃, Li₄SiO₄, Li₄ZrO₄, LiMoO₄, LiAlF₄, Li₃Ni₂, LiBF₄, LiCF₃SO₃, or a combination thereof.

10. The all-solid-state battery of claim 1, wherein
a ratio of an average thickness of the first electrolyte layer and an average thickness of the second electrolyte layer is 1:1 to 15:1.

11. The all-solid-state battery of claim 1, further comprising
a margin layer disposed on the solid electrolyte layer and being laterally adjacent to an edge of the positive electrode layer or the negative electrode layer.

12. An all-solid-state battery, comprising
a positive electrode layer and a negative electrode layer, and a solid electrolyte layer interposed between the positive electrode layer and the negative electrode layer,
wherein the solid electrolyte layer comprises a first electrolyte layer including a glass-ceramic electrolyte including lithium chloride (LiCl);
and a second electrolyte layer disposed on one surface of the first electrolyte layer and including a lithium borosilicate-based electrolyte, the first electrolyte layer is disposed between the negative electrode layer and the second electrolyte layer, and the second electrolyte layer is disposed between the positive electrode layer and the first electrolyte layer.

13. The all-solid-state battery of claim 12, wherein
the glass-ceramic electrolyte further includes a lithium chloroboracite crystal.

14. The all-solid-state battery of claim 12, wherein
the glass-ceramic electrolyte further includes lithium (Li) oxide, boron (B) oxide, silicon (Si) oxide, phosphorus (P) oxide, and germanium (Ge) oxide.

15. The all-solid-state battery of claim 14, wherein
the glass-ceramic electrolyte includes 35 to 55 mol % of lithium (Li) oxide, 30 to 50 mol % of boron (B) oxide, 5 to 15 mol % of silicon (Si) oxide, 0.1 to 5 mol % of phosphorus (P) oxide, 0.1 to 5 mol % of germanium (Ge) oxide, and 0.5 to 10 mol % of lithium chloride based on a total amount of the glass-ceramic electrolyte.

16. The all-solid-state battery of claim 12, wherein
the lithium borosilicate-based electrolyte includes lithium (Li) oxide, silicon (Si) oxide, and boron (B) oxide.

17. The all-solid-state battery of claim 16, wherein
the lithium borosilicate-based electrolyte includes 35 to 65 mol % of lithium (Li) oxide, 5 to 25 mol % of silicon (Si) oxide, and 30 to 50 mol % of boron (B) oxide based on a total amount of the lithium borosilicate-based electrolyte.

18. The all-solid-state battery of claim 16, wherein
the lithium borosilicate-based electrolyte further includes additional oxide including Na (sodium), Mg (magnesium), Al (aluminum), P (phosphorus), K (potassium), Ca (calcium), Ti (titanium), V (vanadium), Cr (chromium), Mn (manganese), Fe (iron), Co (cobalt), Ni (nickel), Cu (copper), Zn (zinc), Ga (gallium), Ge (germanium), Se (selenium), Rb (rubidium), S (sulfur), Y (yttrium), Zr (zirconium), Nb (niobium), Mo (molybdenum), Ag (silver), In (indium), Sn (tin), Sb (antimony), Cs (cesium), Ba (vanadium), Hf (hafnium), Ta (tantalum), W (tungsten), Ph (lead), Bi (bismuth), Au (gold), La (lanthanum), Nd (neodymium), Eu (europium), or a combination thereof.

19. The all-solid-state battery of claim 16, wherein
the lithium borosilicate-based electrolyte further includes an additive, which includes LiF, LiCl, LiBr, LiI, Li₃N, LiPON, Li₂C₂O₄, Li₂CO₃, LiAlCl₄, Li₂O, Li₂S, LiSO₄, Li₂SO₄, Li₃PO₄, Li₃VO₄, Li₄GeO₄, Li₂Si₂O₅, Li₂SiO₃, Li₄SiO₄, Li₄ZrO₄, LiMoO₄, LiAlF₄, Li₃Ni₂, LiBF₄, LiCF₃SO₃, or a combination thereof.

20. The all-solid-state battery of claim 12, wherein
a ratio of an average thickness of the first electrolyte layer and an average thickness of the second electrolyte layer is 1:1 to 15:1.

21. The all-solid-state battery of claim 12, further comprising
a margin layer disposed on the solid electrolyte layer and being laterally adjacent to an edge of the positive electrode layer or the negative electrode layer.
